(19) United States
(12) Patent Application Publication
(10) Pub. No.: US 2014/0173747 A1
(43) Pub. Date: Jun. 19, 2014

(54) DISABLING ACCESS TO APPLICATIONS AND CONTENT IN A PRIVACY MODE

(71) Applicant: APPLE INC., Cupertino, CA (US)

(72) Inventor: Guru Prashanth Govindaraju, San Jose, CA (US)

(73) Assignee: Apple Inc., Cupertino, CA (US)

(21) Appl. No.: 13/714,325

(22) Filed: Dec. 13, 2012

(51) Int. Cl. G06F 21/60; G06F 21/00

(52) U.S. Cl. CPC G06F 21/60
USPC 726/27

(57) ABSTRACT

Methods of disabling access to applications and content in a privacy mode are provided. One or more private applications can be selected on an electronic device. A privacy mode can be enabled, and access to the private applications can be disabled. Additionally, access from public applications to content associated with the private applications can be disabled. Such a feature makes for a more robust privacy mode that can maintain the privacy of content that may otherwise be accessible.

### FIELD OF THE DISCLOSURE

This relates generally to managing access to applications and content on an electronic device.

### BACKGROUND OF THE DISCLOSURE

An electronic device may be shared between users without regard for personal information or content that may be stored on the device. For example, a user may hand her phone to a friend to show a text message or a photo, but the friend can easily access any other application or content on the phone. Even if the friend only uses a single application on the phone, that application may be able to access content from other applications, such as photos.

### SUMMARY OF THE DISCLOSURE

This relates to methods of disabling access to applications and content in a privacy mode. One or more private applications can be selected on an electronic device. A privacy mode can be enabled, and access to the private applications can be disabled. Additionally, access from public applications to content associated with the private applications can be disabled. Such a feature makes for a more robust privacy mode that can maintain the privacy of content that may otherwise be accessible.

### BRIEF DESCRIPTION OF THE DRAWINGS

FIG. 1 illustrates a method of disabling access to applications and content in a privacy mode according to examples of the disclosure.

FIG. 2 is a block diagram illustrating an exemplary API architecture, which may be used in some examples of the disclosure.

FIG. 3 illustrates an exemplary software stack of an API according to examples of the disclosure.

FIG. 4 is a block diagram illustrating exemplary interactions between the touch screen and the other components of the device according to examples of the disclosure.

FIG. 5 is a block diagram illustrating an example of a system architecture that may be embodied within any portable or non-portable device according to examples of the disclosure.

### DETAILED DESCRIPTION

In the following description of examples, reference is made to the accompanying drawings which form a part hereof, and in which it is shown by way of illustration specific examples that can be practiced. It is to be understood that other examples can be used and structural changes can be made without departing from the scope of the disclosed examples.

Various examples of the disclosure are related to methods of disabling access to applications and content in a privacy mode. One or more private applications can be selected on an electronic device. A privacy mode can be enabled, and access to the private applications can be disabled. Additionally, access from public applications to content associated with the private applications can be disabled. Such a feature makes for a more robust privacy mode that can maintain the privacy of content that may otherwise be accessible.

Although examples disclosed herein may be described and illustrated herein primarily in terms of a mobile device, it should be understood that the examples are not so limited, but are additionally applicable to electronic devices generally.

In an electronic device, an application may be associated with content. The application and/or an underlying operating system may make that content accessible to other applications. In a privacy mode, a user may desire that not just the application be inaccessible but also content associated with the application.

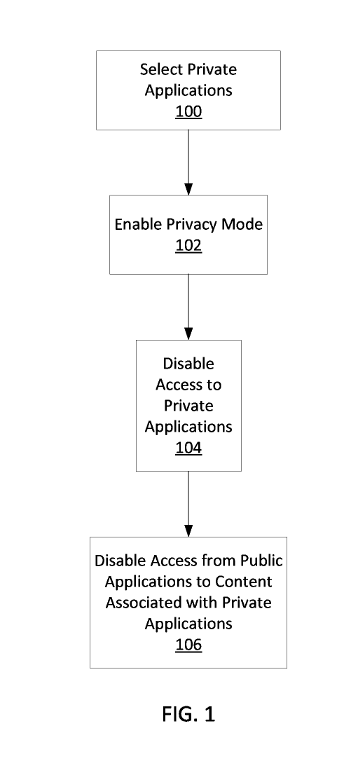

FIG. 1 illustrates a method of disabling access to applications and content in a privacy mode according to examples of the disclosure. One or more private applications may be selected (100). In some examples, a user may select one or more applications to be private applications. In other examples, one or more applications may be automatically selected as private applications. For example, a photo gallery application, an email application, and a text message application may be automatically selected as private applications.

In some examples, a user may select one or more application categories as private categories, and then applications associated with those categories can be automatically selected as private applications. For example, a user may select categories including messaging, photos, and social media, among other possibilities. If a messaging category is selected, then any application that is used for messaging, such as an email application and a messaging application may be selected as a private application. If a photos category is selected, then any application that is used for photos, such as a photo gallery application and one or more camera applications may be selected as a private application. Additionally, in some examples, once a user selects a category to be private, any application associated with that category installed thereafter can be automatically selected as private. For example, if a user selects a photos category as a private category and then later installs a new camera application, the new camera application can be automatically selected as private.

A privacy mode may be enabled (102). The privacy mode may be enabled based on user input. For example, the privacy mode may be enabled based on a user selection of an icon associated with the privacy mode. The privacy mode may be enabled based on any user input, including touch input, a multitouch gesture, voice input, facial recognition, and/or a password, among other possibilities. Additionally, the privacy mode may be later disabled based on user input. In some examples, where the privacy mode can be enabled based on a gesture, the privacy mode may be disabled based on the same gesture performed in reverse. In some examples, the electronic device may have a general password to access the device, and a password to enable and/or disable the privacy mode may be different from the general password.

Access to the one or more private applications may be disabled in response to the enabling of the privacy mode (104). Access to a private application may be disabled by removing an indication of the application (such as an icon or a name of the application) from a menu of available applications. In some examples, a user may still attempt to select the private application, but the application can be prevented from executing. Additionally, disabled access may be indicated by altering the display of an indication of the private application by displaying the indication in grayscale or otherwise dimmed compared to indications of other applications.

Access from one or more public applications to content associated with the one or more private applications may be disabled in response to the enabling of the privacy mode (106). Disabling access to content associated with private applications can be accomplished in a number of ways depending on how such content is made available to public applications.

In some examples, an application can make content available to other applications by sending information regarding the content to a content store module of the operating system. The content store can then be queried by other applications to receive access to the content. When the privacy mode is enabled, any content associated with a private application can be marked as private in the content store, and the content store can deny access to such content from other applications.

For example, a camera application may send information regarding any photos taken with the application to a content store module. Then, other applications such as a social networking application may query the content store to gain access to any photos on the device, including those from the camera application. If the camera application is a private application in a privacy mode, but the social networking application is a public application, then the photos taken by the camera application may be marked as private in the content store. Consequently, if the social networking application queries the content store for photos, the photos taken by the camera application may not be accessible to the social networking application.

The examples discussed above can be implemented in one or more Application Programming Interfaces (APIs). An API is an interface implemented by a program code component or hardware component (hereinafter “API-implementing component”) that allows a different program code component or hardware component (hereinafter “API-calling component”) to access and use one or more functions, methods, procedures, data structures, classes, and/or other services provided by the API-implementing component. An API can define one or more parameters that are passed between the API-calling component and the API-implementing component.

The above-described features can be implemented as part of an application program interface (API) that can allow it to be incorporated into different applications (e.g., spreadsheet apps) utilizing touch input as an input mechanism. An API can allow a developer of an API-calling component (which may be a third party developer) to leverage specified features, such as those described above, provided by an API-implementing component. There may be one API-calling component or there may be more than one such component. An API can be a source code interface that a computer system or program library provides in order to support requests for services from an application. An operating system (OS) can have multiple APIs to allow applications running on the OS to call one or more of those APIs, and a service (such as a program library) can have multiple APIs to allow an application that uses the service to call one or more of those APIs. An API can be specified in terms of a programming language that can be interpreted or compiled when an application is built.

In some examples, the API-implementing component may provide more than one API, each providing a different view of the functionality implemented by the API-implementing component, or with different aspects that access different aspects of the functionality implemented by the API-implementing component. For example, one API of an API-implementing component can provide a first set of functions and can be exposed to third party developers, and another API of the API-implementing component can be hidden (not exposed) and provide a subset of the first set of functions and also provide another set of functions, such as testing or debugging functions which are not in the first set of functions. In other examples the API-implementing component may itself call one or more other components via an underlying API and thus be both an API-calling component and an API-implementing component.

An API defines the language and parameters that API-calling components use when accessing and using specified features of the API-implementing component. For example, an API-calling component accesses the specified features of the API-implementing component through one or more API calls or invocations (embodied for example by function or method calls) exposed by the API and passes data and control information using parameters via the API calls or invocations. The API-implementing component may return a value through the API in response to an API call from an API-calling component. While the API defines the syntax and result of an API call (e.g., how to invoke the API call and what the API call does), the API may not reveal how the API call accomplishes the function specified by the API call. Various API calls are transferred via the one or more application programming interfaces between the calling (API-calling component) and an API-implementing component. Transferring the API calls may include issuing, initiating, invoking, calling, receiving, returning, or responding to the function calls or messages; in other words, transferring can describe actions by either of the API-calling component or the API-implementing component. The function calls or other invocations of the API may send or receive one or more parameters through a parameter list or other structure. A parameter can be a constant, key, data structure, object, object class, variable, data type, pointer, array, list or a pointer to a function or method or another way to reference a data or other item to be passed via the API.

Furthermore, data types or classes may be provided by the API and implemented by the API-implementing component. Thus, the API-calling component may declare variables, use pointers to, use or instantiate constant values of such types or classes by using definitions provided in the API.

Generally, an API can be used to access a service or data provided by the API-implementing component or to initiate performance of an operation or computation provided by the API-implementing component. By way of example, the API-implementing component and the API-calling component may each be any one of an operating system, a library, a device driver, an API, an application program, or other module (it should be understood that the API-implementing component and the API-calling component may be the same or different type of module from each other). API-implementing components may in some cases be embodied at least in part in firmware, microcode, or other hardware logic. In some examples, an API may allow a client program to use the services provided by a Software Development Kit (SDK) library. In other examples an application or other client program may use an API provided by an Application Framework. In these examples the application or client program may incorporate calls to functions or methods provided by the SDK and provided by the API or use data types or objects defined in the SDK and provided by the API. An Application Framework may in these examples provide a main event loop for a program that responds to various events defined by the Framework. The API allows the application to specify the events and the responses to the events using the Application Framework. In some implementations, an API call can report to an application the capabilities or state of a hardware device, including those related to aspects such as input capabilities and state, output capabilities and state, processing capability, power state, storage capacity and state, communications capability, etc., and the API may be implemented in part by firmware, microcode, or other low level logic that executes in part on the hardware component.

The API-calling component may be a local component (i.e., on the same data processing system as the API-implementing component) or a remote component (i.e., on a different data processing system from the API-implementing component) that communicates with the API-implementing component through the API over a network. It should be understood that an API-implementing component may also act as an API-calling component (i.e., it may make API calls to an API exposed by a different API-implementing component) and an API-calling component may also act as an API-implementing component by implementing an API that is exposed to a different API-calling component.

The API may allow multiple API-calling components written in different programming languages to communicate with the API-implementing component (thus the API may include features for translating calls and returns between the API-implementing component and the API-calling component); however the API may be implemented in terms of a specific programming language. An API-calling component can, in one example, call APIs from different providers such as a set of APIs from an OS provider and another set of APIs from a plug-in provider and another set of APIs from another provider (e.g. the provider of a software library) or creator of the another set of APIs.

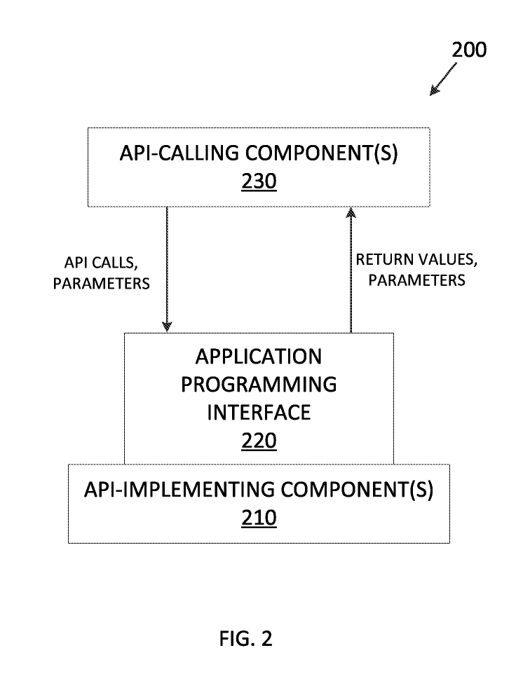

FIG. 2 is a block diagram illustrating an exemplary API architecture, which may be used in some examples of the disclosure. As shown in FIG. 2, the API architecture 200 includes the API-implementing component 210 (e.g., an operating system, a library, a device driver, an API, an application program, software or other module) that implements the API 220. The API 220 specifies one or more functions, methods, classes, objects, protocols, data structures, formats and/or other features of the API-implementing component that may be used by the API-calling component 230. The API 220 can specify at least one calling convention that specifies how a function in the API-implementing component receives parameters from the API-calling component and how the function returns a result to the API-calling component. The API-calling component 230 (e.g., an operating system, a library, a device driver, an API, an application program, software or other module), makes API calls through the API 220 to access and use the features of the API-implementing component 210 that are specified by the API 220. The API-implementing component 210 may return a value through the API 220 to the API-calling component 230 in response to an API call.

It will be appreciated that the API-implementing component 210 may include additional functions, methods, classes, data structures, and/or other features that are not specified through the API 220 and are not available to the API-calling component 230. It should be understood that the API-calling component 230 may be on the same system as the API-implementing component 210 or may be located remotely and accesses the API-implementing component 210 using the API 220 over a network. While FIG. 2 illustrates a single API-calling component 230 interacting with the API 220, it should be understood that other API-calling components, which may be written in different languages (or the same language) than the API-calling component 230, may use the API 220.

The API-implementing component 210, the API 220, and the API-calling component 230 may be stored in a non-transitory machine-readable storage medium, which includes any mechanism for storing information in a form readable by a machine (e.g., a computer or other data processing system). For example, a machine-readable medium includes magnetic disks, optical disks, random access memory; read only memory, flash memory devices, etc.

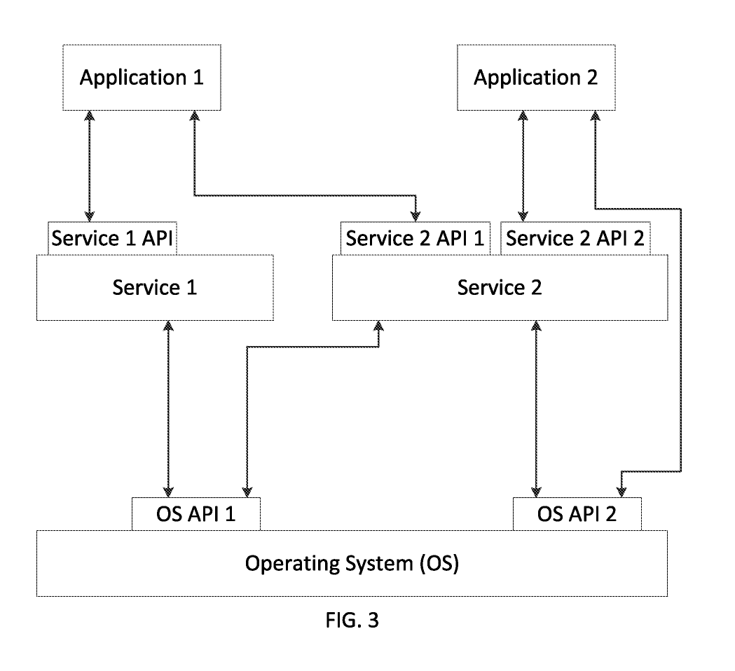

In the exemplary software stack shown in FIG. 3, applications can make calls to Services A or B using several Service APIs and to Operating System (OS) using several OS APIs. Services A and B can make calls to OS using several OS APIs.

Note that the Service 2 has two APIs, one of which (Service 2 API 1) receives calls from and returns values to Application 1 and the other (Service 2 API 2) receives calls from and returns values to Application 2. Service 1 (which can be, for example, a software library) makes calls to and receives returned values from OS API 1, and Service 2 (which can be, for example, a software library) makes calls to and receives returned values from both OS API 1 and OS API 2. Application 2 makes calls to and receives returned values from OS API 2.

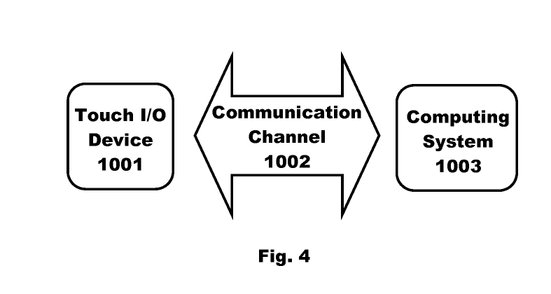

FIG. 4 is a block diagram illustrating exemplary interactions between the touch screen and the other components of the device. Described examples may include touch I/O device 1001 that can receive touch input for interacting with computing system 1003 via wired or wireless communication channel 1002. Touch I/O device 1001 may be used to provide user input to computing system 1003 in lieu of or in combination with other input devices such as a keyboard, mouse, etc. One or more touch I/O devices 1001 may be used for providing user input to computing system 1003. Touch I/O device 1001 may be an integral part of computing system 1003 (e.g., touch screen on a smartphone or a tablet PC) or may be separate from computing system 1003.

Touch I/O device 1001 may include a touch sensitive panel which is wholly or partially transparent, semitransparent, non-transparent, opaque or any combination thereof. Touch I/O device 1001 may be embodied as a touch screen, touch pad, a touch screen functioning as a touch pad (e.g., a touch screen replacing the touchpad of a laptop), a touch screen or touchpad combined or incorporated with any other input device (e.g., a touch screen or touchpad disposed on a keyboard) or any multi-dimensional object having a touch sensitive surface for receiving touch input.

In one example, touch I/O device 1001 embodied as a touch screen may include a transparent and/or semitransparent touch sensitive panel partially or wholly positioned over at least a portion of a display. According to this example, touch I/O device 1001 functions to display graphical data transmitted from computing system 1003 (and/or another source) and also functions to receive user input. In other examples, touch I/O device 1001 may be embodied as an integrated touch screen where touch sensitive components/devices are integral with display components/devices. In still other examples a touch screen may be used as a supplemental or additional display screen for displaying supplemental or the same graphical data as a primary display and to receive touch input.

Touch I/O device 1001 may be configured to detect the location of one or more touches or near touches on device 1001 based on capacitive, resistive, optical, acoustic, inductive, mechanical, chemical measurements, or any phenomena that can be measured with respect to the occurrences of the one or more touches or near touches in proximity to device 1001. Software, hardware, firmware or any combination thereof may be used to process the measurements of the detected touches to identify and track one or more gestures. A gesture may correspond to stationary or non-stationary, single or multiple, touches or near touches on touch I/O device 1001. A gesture may be performed by moving one or more fingers or other objects in a particular manner on touch I/O device 1001 such as tapping, pressing, rocking, scrubbing, twisting, changing orientation, pressing with varying pressure and the like at essentially the same time, contiguously, or consecutively. A gesture may be characterized by, but is not limited to a pinching, sliding, swiping, rotating, flexing, dragging, or tapping motion between or with any other finger or fingers. A single gesture may be performed with one or more hands, by one or more users, or any combination thereof.

Computing system 1003 may drive a display with graphical data to display a graphical user interface (GUI). The GUI may be configured to receive touch input via touch I/O device 1001. Embodied as a touch screen, touch I/O device 1001 may display the GUI. Alternatively, the GUI may be displayed on a display separate from touch I/O device 1001. The GUI may include graphical elements displayed at particular locations within the interface. Graphical elements may include but are not limited to a variety of displayed virtual input devices including virtual scroll wheels, a virtual keyboard, virtual knobs, virtual buttons, any virtual UI, and the like. A user may perform gestures at one or more particular locations on touch I/O device 1001 which may be associated with the graphical elements of the GUI. In other examples, the user may perform gestures at one or more locations that are independent of the locations of graphical elements of the GUI. Gestures performed on touch I/O device 1001 may directly or indirectly manipulate, control, modify, move, actuate, initiate or generally affect graphical elements such as cursors, icons, media files, lists, text, all or portions of images, or the like within the GUI. For instance, in the case of a touch screen, a user may directly interact with a graphical element by performing a gesture over the graphical element on the touch screen. Alternatively, a touch pad generally provides indirect interaction. Gestures may also affect non-displayed GUI elements (e.g., causing user interfaces to appear) or may affect other actions within computing system 1003 (e.g., affect a state or mode of a GUI, application, or operating system). Gestures may or may not be performed on touch I/O device 1001 in conjunction with a displayed cursor. For instance, in the case in which gestures are performed on a touchpad, a cursor (or pointer) may be displayed on a display screen or touch screen and the cursor may be controlled via touch input on the touchpad to interact with graphical objects on the display screen. In other examples in which gestures are performed directly on a touch screen, a user may interact directly with objects on the touch screen, with or without a cursor or pointer being displayed on the touch screen.

Feedback may be provided to the user via communication channel 1002 in response to or based on the touch or near touches on touch I/O device 1001. Feedback may be transmitted optically, mechanically, electrically, olfactory, acoustically, or the like or any combination thereof and in a variable or non-variable manner.

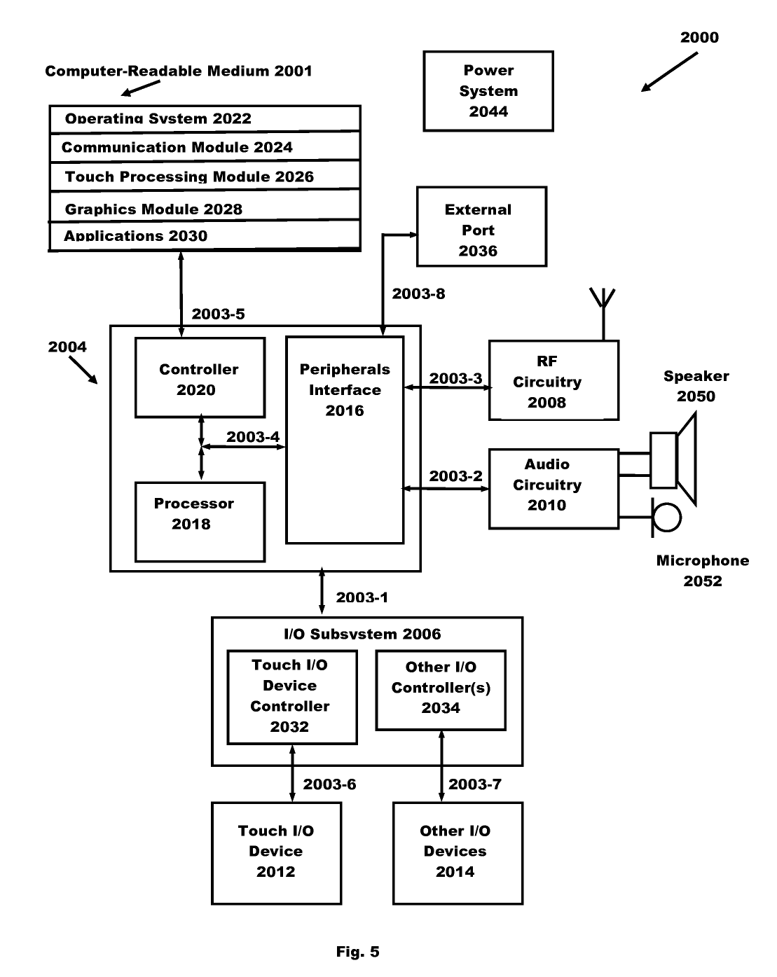

Attention is now directed towards examples of a system architecture that may be embodied within any portable or non-portable device including but not limited to a communication device (e.g. mobile phone, smart phone), a multi-media device (e.g., MP3 player, TV, radio), a portable or handheld computer (e.g., tablet, netbook, laptop), a desktop computer, an All-In-One desktop, a peripheral device, or any other system or device adaptable to the inclusion of system architecture 2000, including combinations of two or more of these types of devices. FIG. 5 is a block diagram of one example of system 2000 that generally includes one or more computer-readable mediums 2001, processing system 2004, I/O subsystem 2006, radio frequency (RF) circuitry 2008, audio circuitry 2010, and gaze detection circuitry 2011. These components may be coupled by one or more communication buses or signal lines 2003.

It should be apparent that the architecture shown in FIG. 5 is only one example architecture of system 2000, and that system 2000 could have more or fewer components than shown, or a different configuration of components. The various components shown in FIG. 8 can be implemented in hardware, software, firmware or any combination thereof, including one or more signal processing and/or application specific integrated circuits.

RF circuitry 2008 is used to send and receive information over a wireless link or network to one or more other devices and includes well-known circuitry for performing this function. RF circuitry 2008 and audio circuitry 2010 are coupled to processing system 2004 via peripherals interface 2016. Interface 2016 includes various known components for establishing and maintaining communication between peripherals and processing system 2004. Audio circuitry 2010 is coupled to audio speaker 2050 and microphone 2052 and includes known circuitry for processing voice signals received from interface 2016 to enable a user to communicate in real-time with other users. In some examples, audio circuitry 2010 includes a headphone jack (not shown).

Peripherals interface 2016 couples the input and output peripherals of the system to processor 2018 and computer-readable medium 2001. One or more processors 2018 communicate with one or more computer-readable mediums 2001 via controller 2020. Computer-readable medium 2001 can be any device or medium that can store code and/or data for use by one or more processors 2018. Medium 2001 can include a memory hierarchy, including but not limited to cache, main memory and secondary memory. The memory hierarchy can be implemented using any combination of RAM (e.g., SRAM, DRAM, DDRAM), ROM, FLASH, magnetic and/or optical storage devices, such as disk drives, magnetic tape, CDs (compact disks) and DVDs (digital video discs). Medium 2001 may also include a transmission medium for carrying information-bearing signals indicative of computer instructions or data (with or without a carrier wave upon which the signals are modulated). For example, the transmission medium may include a communications network, including but not limited to the Internet (also referred to as the World Wide Web), intranet(s), Local Area Networks (LANs), Wide Local Area Networks (WLANs), Storage Area Networks (SANs), Metropolitan Area Networks (MAN) and the like.

One or more processors 2018 run various software components stored in medium 2001 to perform various functions for system 2000. In some examples, the software components include operating system 2022, communication module (or set of instructions) 2024, touch processing module (or set of instructions) 2026, graphics module (or set of instructions) 2028, and one or more applications (or set of instructions) 2030. Each of these modules and above noted applications correspond to a set of instructions for performing one or more functions described above and the methods described in this application (e.g., the computer-implemented methods and other information processing methods described herein). These modules (i.e., sets of instructions) need not be implemented as separate software programs, procedures or modules, and thus various subsets of these modules may be combined or otherwise re-arranged in various examples. In some examples, medium 2001 may store a subset of the modules and data structures identified above. Furthermore, medium 2001 may store additional modules and data structures not described above.

Operating system 2022 includes various procedures, sets of instructions, software components and/or drivers for controlling and managing general system tasks (e.g., memory management, storage device control, power management, etc.) and facilitates communication between various hardware and software components.

Communication module 2024 facilitates communication with other devices over one or more external ports 2036 or via RF circuitry 2008 and includes various software components for handling data received from RF circuitry 2008 and/or external port 2036.

Graphics module 2028 includes various known software components for rendering, animating and displaying graphical objects on a display surface. In examples in which touch I/O device 2012 is a touch sensitive display (e.g., touch screen), graphics module 2028 includes components for rendering, displaying, and animating objects on the touch sensitive display.

One or more applications 2030 can include any applications installed on system 2000, including without limitation, a browser, address book, contact list, email, instant messaging, word processing, keyboard emulation, widgets, JAVA-enabled applications, encryption, digital rights management, voice recognition, voice replication, location determination capability (such as that provided by the global positioning system (GPS)), a music player, etc.

Touch processing module 2026 includes various software components for performing various tasks associated with touch I/O device 2012 including but not limited to receiving and processing touch input received from I/O device 2012 via touch I/O device controller 2032.

I/O subsystem 2006 is coupled to touch I/O device 2012 and one or more other I/O devices 2014 for controlling or performing various functions. Touch I/O device 2012 communicates with processing system 2004 via touch I/O device controller 2032, which includes various components for processing user touch input (e.g., scanning hardware). One or more other input controllers 2034 receives/sends electrical signals from/to other I/O devices 2014. Other I/O devices 2014 may include physical buttons, dials, slider switches, sticks, keyboards, touch pads, additional display screens, or any combination thereof.

If embodied as a touch screen, touch I/O device 2012 displays visual output to the user in a GUI. The visual output may include text, graphics, video, and any combination thereof. Some or all of the visual output may correspond to user-interface objects. Touch I/O device 2012 forms a touch-sensitive surface that accepts touch input from the user. Touch I/O device 2012 and touch screen controller 2032 (along with any associated modules and/or sets of instructions in medium 2001) detects and tracks touches or near touches (and any movement or release of the touch) on touch I/O device 2012 and converts the detected touch input into interaction with graphical objects, such as one or more user-interface objects. In the case in which device 2012 is embodied as a touch screen, the user can directly interact with graphical objects that are displayed on the touch screen. Alternatively, in the case in which device 2012 is embodied as a touch device other than a touch screen (e.g., a touch pad), the user may indirectly interact with graphical objects that are displayed on a separate display screen embodied as I/O device 2014.

Touch I/O device 2012 may be analogous to the multi-touch sensitive surface described in the following U.S. patents: U.S. Pat. No. 6,323,846 (Westerman et al.), U.S. Pat. No. 6,570,557 (Westerman et al.), and/or U.S. Pat. No. 6,677,932 (Westerman), and/or U.S. Patent Publication 2002/0015024A1, each of which is hereby incorporated by reference.

Examples in which touch I/O device 2012 is a touch screen, the touch screen may use LCD (liquid crystal display) technology, LPD (light emitting polymer display) technology, OLED (organic LED), or OEL (organic electro luminescence), although other display technologies may be used in other examples.

Feedback may be provided by touch I/O device 2012 based on the user's touch input as well as a state or states of what is being displayed and/or of the computing system. Feedback may be transmitted optically (e.g., light signal or displayed image), mechanically (e.g., haptic feedback, touch feedback, force feedback, or the like), electrically (e.g., electrical stimulation), olfactory, acoustically (e.g., beep or the like), or the like or any combination thereof and in a variable or non-variable manner.

System 2000 also includes power system 2044 for powering the various hardware components and may include a power management system, one or more power sources, a recharging system, a power failure detection circuit, a power converter or inverter, a power status indicator and any other components typically associated with the generation, management and distribution of power in portable devices.

In some examples, peripherals interface 2016, one or more processors 2018, and memory controller 2020 may be implemented on a single chip, such as processing system 2004. In some other examples, they may be implemented on separate chips.

Examples of the disclosure can be advantageous in providing a robust privacy mode for an electronic device that intuitively disables access to applications and content that a user would like to keep private from other users of the device.

In some examples, a non-transitory computer readable storage medium is disclosed. The medium can have stored therein instructions, which when executed by a mobile device, cause the device perform a method as described by one or more examples herein.

In some examples, a method of a computing device is disclosed. The method can include selecting one or more private applications; enabling a privacy mode; and in response to enabling the privacy mode, disabling access to the one or more private applications and disabling access from one or more public applications to content associated with the one or more private applications. Additionally or alternatively to one or more of the examples disclosed above, the one or more private applications can be selected based on a category of private applications. Additionally or alternatively to one or more of the examples disclosed above, the category can be a photos category and the one or more private applications can include a photo gallery application and a camera application. Additionally or alternatively to one or more of the examples disclosed above, enabling the privacy mode can be based on a first gesture, and the method can further include disabling the privacy mode based on a second gesture. Additionally or alternatively to one or more of the examples disclosed above, the second gesture can be the first gesture performed in reverse. Additionally or alternatively to one or more of the examples disclosed above, disabling access to the one or more private applications can include removing an indication of the one or more private applications from a menu of applications. Additionally or alternatively to one or more of the examples disclosed above, disabling access to the content can include marking the content as private in a content store.

In some examples, an electronic device is disclosed. The electronic device can include a processor to execute instructions; and a memory coupled with the processor to store instructions, which when executed by the processor, cause the processor to perform operations to generate an application programming interface (API) that allows an API-calling component to perform the following operations: selecting one or more private applications; enabling a privacy mode; and in response to enabling the privacy mode, disabling access to the one or more private applications and disabling access from one or more public applications to content associated with the one or more private applications. Additionally or alternatively to one or more of the examples disclosed above, the one or more private applications can be selected based on a category of private applications. Additionally or alternatively to one or more of the examples disclosed above, the category can be a photos category and the one or more private applications can include a photo gallery application and a camera application. Additionally or alternatively to one or more of the examples disclosed above, enabling the privacy mode can be based on a first gesture, and the operations can further include disabling the privacy mode based on a second gesture. Additionally or alternatively to one or more of the examples disclosed above, the second gesture can be the first gesture performed in reverse. Additionally or alternatively to one or more of the examples disclosed above, disabling access to the one or more private applications can include removing an indication of the one or more private applications from a menu of applications. Additionally or alternatively to one or more of the examples disclosed above, disabling access to the content can include marking the content as private in a content store.

In some examples, a non-transitory computer readable storage medium is disclosed. The medium can have stored therein instructions, which when executed by a mobile device, cause the device perform a method as described by one or more examples above.

Although the disclosed examples have been fully described with reference to the accompanying drawings, it is to be noted that various changes and modifications will become apparent to those skilled in the art. Such changes and modifications are to be understood as being included within the scope of the disclosed examples as defined by the appended claims.

What is claimed is:

1. A method of a computing device, the method comprising:
selecting one or more private applications;
enabling a privacy mode; and
in response to enabling the privacy mode, disabling access to the one or more private applications and disabling access from one or more public applications to content associated with the one or more private applications.

2. The method of claim 1, wherein the one or more private applications are selected based on a category of private applications.

3. The method of claim 2, wherein the category is a photos category and the one or more private applications include a photo gallery application and a camera application.

4. The method of claim 1, wherein enabling the privacy mode is based on a first gesture, the method further comprising:
disabling the privacy mode based on a second gesture.

5. The method of claim 4, wherein the second gesture is the first gesture performed in reverse.

6. The method of claim 1, wherein disabling access to the one or more private applications includes removing an indication of the one or more private applications from a menu of applications.

7. The method of claim 1, wherein disabling access to the content includes marking the content as private in a content store.

8. An electronic device, comprising:
a processor to execute instructions; and
a memory coupled with the processor to store instructions, which when executed by the processor, cause the processor to perform operations to generate an application programming interface (API) that allows an API-calling component to perform the following operations:
selecting one or more private applications;
enabling a privacy mode; and
in response to enabling the privacy mode, disabling access to the one or more private applications and disabling access from one or more public applications to content associated with the one or more private applications.

9. The electronic device of claim 8, wherein the one or more private applications are selected based on a category of private applications.

10. The electronic device of claim 9, wherein the category is a photos category and the one or more private applications include a photo gallery application and a camera application.

11. The electronic device of claim 8, wherein enabling the privacy mode is based on a first gesture, the operations further comprising:
disabling the privacy mode based on a second gesture.

12. The electronic device of claim 11, wherein the second gesture is the first gesture performed in reverse.

13. The electronic device of claim 8, wherein disabling access to the one or more private applications includes removing an indication of the one or more private applications from a menu of applications.

14. The electronic device of claim 8, wherein disabling access to the content includes marking the content as private in a content store.

15. A non-transitory computer readable storage medium having stored therein instructions, which when executed by a mobile device, cause the device to perform a method comprising:
selecting one or more private applications;
enabling a privacy mode; and
in response to enabling the privacy mode, disabling access to the one or more private applications and disabling access from one or more public applications to content associated with the one or more private applications.

16. The non-transitory computer readable storage medium of claim 15, wherein the one or more private applications are selected based on a category of private applications.

17. The non-transitory computer readable storage medium of claim 16, wherein the category is a photos category and the one or more private applications include a photo gallery application and a camera application.

18. The non-transitory computer readable storage medium of claim 15, wherein enabling the privacy mode is based on a first gesture, the method further comprising:
disabling the privacy mode based on a second gesture.

19. The non-transitory computer readable storage medium of claim 18, wherein the second gesture is the first gesture performed in reverse.

20. The non-transitory computer readable storage medium of claim 15, wherein disabling access to the one or more private applications includes removing an indication of the one or more private applications from a menu of applications.

21. The non-transitory computer readable storage medium of claim 15, wherein disabling access to the content includes marking the content as private in a content store.
